(19) United States
(12) Patent Application Publication
(10) Pub. No.: US 2026/0057495 A1
(43) Pub. Date: Feb. 26, 2026

(54) GENERATIVE MODELS FOR HANDLING OCCLUSIONS

(71) Applicant: QUALCOMM Incorporated, San Diego, CA (US)

(72) Inventors: Shubhankar Mangesh BORSE, San Diego, CA (US); Ming-Yuan YU, Austin, TX (US); Varun RAVI KUMAR, San Diego, CA (US); Senthil Kumar YOGAMANI, San Diego, CA (US); Fatih Murat PORIKLI, San Diego, CA (US)

(21) Appl. No.: 18/811,670

(22) Filed: Aug. 21, 2024

(51) Int. Cl. G06T 5/77; G06T 5/60; G06T 7/11; G06T 7/215

(52) U.S. Cl. CPC G06T 5/77; G06T 5/60; G06T 7/11; G06T 7/215; G06T 2207/10016; G06T 2207/10028; G06T 2207/20081

(57) ABSTRACT

Certain aspects of the present disclosure provide techniques for performing inpainting of one or more occluded regions in a frame, including: obtaining an occlusion mask corresponding to a first occluded region of one or more occluded regions in a frame, wherein the first occluded region corresponds to a first object; inputting the frame and the occlusion mask into a first machine learning (ML) model trained to inpaint the frame; and obtaining as output from the first ML model an inpainted frame that corresponds to the frame with the first object inpainted in the first occluded region.

### FIELD OF THE DISCLOSURE

Aspects of the present disclosure relate to generative models, and more particularly, to techniques for utilizing generative models for handling occlusions.

### DESCRIPTION OF RELATED ART

The field of autonomous driving has observed significant advancements in recent years, with the development of sophisticated perception systems that enable vehicles to understand and navigate their surroundings. These perception systems typically rely on various sensors, such as cameras, LIDAR, and RADAR, to gather data about the environment. The collected data can then be processed using computer vision and machine learning techniques to detect and track objects in the vehicle's vicinity.

A challenge in object detection (e.g., and tracking), such as for autonomous driving, is the presence of occlusions. Occlusions occur when an object of interest is partially or fully obscured by another object in the scene. For example, a pedestrian crossing the street may be temporarily hidden behind a parked car, or a vehicle in front may be partially occluded by a tree or a building. These occlusions can impact the accuracy and reliability of object detection and tracking algorithms.

Traditional approaches to handling occlusions in object detection and tracking often rely on heuristics or rule-based methods. These methods may attempt to estimate the location and trajectory of occluded objects based on their last known position and velocity. However, such approaches can be prone to errors and may struggle to accurately predict the behavior of occluded objects, especially in complex and dynamic environments.

Moreover, the advent of 3D object detection and tracking techniques has introduced additional challenges in handling occlusions. Unlike 2D object detection, which operates on individual image frames, 3D object detection may consider the spatial and temporal information present in point cloud sequences or other 3D data representations. The presence of occlusions in 3D space can further complicate the task of accurately detecting and tracking objects, as the occluded portions of an object may not be visible from all viewpoints.

To address these challenges, various approaches to improve the robustness of object detection and tracking algorithms in the presence of occlusions have been explored. Such approaches include the use of multiple sensors to obtain a more comprehensive view of the scene, the development of advanced algorithms that can reason about the spatial and temporal relationships between objects, and the incorporation of prior knowledge about object behavior and scene geometry. However, there remains a need for more effective and efficient solutions to handle occlusions, especially in 3D object detection and tracking for autonomous driving applications.

### SUMMARY

One aspect provides a method for performing inpainting of one or more occluded regions in a frame. The method may include obtaining an occlusion mask corresponding to a first occluded region of one or more occluded regions in the frame, wherein the first occluded region corresponds to a first object; inputting the frame and the occlusion mask into a first machine learning (ML) model trained to inpaint the frame; and obtaining as output from the first ML model an inpainted frame that corresponds to the frame with the first object inpainted in the first occluded region.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a block diagram illustrating an example system for inpainting occluded regions in a frame, in accordance with aspects of the present disclosure.

FIG. 2 depicts a block diagram illustrating an example system for generating an occlusion mask, in accordance with aspects of the present disclosure.

FIG. 3 depicts a block diagram illustrating additional details of an occlusion mask generator, in accordance with aspects of the present disclosure.

FIG. 4 depicts a block diagram illustrating an example object detection and tracking system for processing one or more frame(s) and generating tracklets, in accordance with aspects of the present disclosure.

FIG. 5 depicts a block diagram illustrating an example system for object tracking and inpainting, in accordance with aspects of the present disclosure.

FIG. 6 depicts a block diagram illustrating an example process for inpainting occluded regions in a sequence of frames, in accordance with aspects of the present disclosure.

FIG. 7 depicts a block diagram illustrating an example system for training an inpainting model using a loss function, in accordance with aspects of the present disclosure.

FIG. 8 illustrates an example artificial intelligence (AI) architecture that may be used for AI-enhanced wireless communications.

FIG. 9 illustrates an example AI architecture of a first device that is in communication with a second device.

FIG. 10 illustrates an example artificial neural network.

FIG. 11 depicts an example method for performing inpainting of one or more occluded regions in a frame in accordance with aspects of the present disclosure.

FIG. 12 depicts aspects of an example processing system in accordance with aspects of the present disclosure.

### DETAILED DESCRIPTION

Aspects of the present disclosure provide apparatuses, methods, processing systems, and computer-readable mediums for perform inpainting of one or more occluded regions in a frame.

Some object tracking systems often struggle when objects become occluded in a frame (e.g., of a sequence of frames). When an object is occluded, the tracking system may lose track of the object's identity, assigning it a new identifier when it reappears. This can lead to fragmented and inaccurate object trajectories over time. Occlusions pose a significant technical challenge for robustly tracking objects in real-world scenarios with dynamic scenes.

Occlusions can occur in various forms, such as partial occlusions where only a portion of the object is blocked from view, or full occlusions where the entire object is hidden for a period of time. Existing tracking approaches often rely on appearance-based matching or motion prediction to handle occlusions. However, these methods often have limitations. For example, appearance-based matching can fail when an object's appearance changes due to an occlusion, while motion prediction may become unreliable for long-term occlusions or sudden changes in object trajectory. Moreover, in applications such as autonomous driving or video surveillance, maintaining accurate and consistent object identities may be important for decision-making and scene understanding. Fragmented trajectories caused by occlusions can lead to incorrect analysis and potentially dangerous situations. Therefore, there is a strong need for a more robust and effective solution to handle occlusions in object tracking.

To address this problem, in certain aspects, techniques are described that leverage an inpainting model to reconstruct the appearance of occluded objects. In certain aspects, a system may detect an occlusion in a frame and generate an occlusion mask, for example using a segmentation model. The occlusion mask, along with the frame may be input into an inpainting model trained to inpaint one or more occluded regions. In some aspects, inpainting may refer to the process of reconstructing (e.g., filling) occluded portions of a frame using surrounding contextual information from adjacent pixels or regions to recreate the occluded content. In some aspects, an inpainted frame may refer to a frame that has undergone this process, specifically where an object is inpainted in an occluded region. In some aspects, an inpainting model may receive a frame with an occluded region and an occlusion mask as input, and generate an inpainted frame where the inpainted frame corresponds to the previously received frame and the previously occluded region is filled in with recreated content. In some aspects, the inpainting model may be trained to learn to infer the occluded content based on the visible parts of the frame and the model's understanding of an object's appearance and characteristics acquired during training.

For example, in certain aspects, a diffusion model may fill in missing pixels of the occluded object based on the visible parts and learned priors, providing a reconstructed portion of the previously occluded object. In some aspects, the learned priors may refer to the knowledge or understanding that the inpainting model has acquired during a training process about the appearance and characteristics of objects. The learned priors may represent the inpainting model's expectations or assumptions based on the training data used to train the inpainting model. In certain aspects, the inpainting model may use the learned priors to make informed predictions and reconstruct the occluded portion of the object. In some aspects, the inpainted frames may then be provided to an object tracking module to enable continuous tracking of object identities, even through occlusions.

In some aspects, a diffusion model may be used to perform the inpainting of the occluded region. In certain aspects, by adapting a diffusion model for the specific task of inpainting occluded regions, the system can leverage the model's learned understanding of object appearance and motion to create plausible reconstructions of occluded objects. The model may be trained on a large dataset of frame information, such as using synthetically generated occlusions, allowing the model to learn robust representations for a variety of object categories and occlusion scenarios.

In some aspects, to address problems related to identity switch where a tracking system incorrectly assigns a unique identifier to an object that has already been tracked, an object may be propagated and continuously tracked throughout an entire sequence of frames, even during periods of occlusion, and even when the object may not be visible in a frame. Identity switching may generally occur due to an occlusion or a complex interaction between objects, resulting in the tracking system mistakenly believing that a previously tracked object is a new, distinct object, which can negatively impact downstream applications where maintaining consistent object identities may be needed. However, continuously propagating tracked objects may become impractical for long-term tracking due to increasing memory requirements and computational demands. In some aspects, a sliding window-based approach can be implemented which considers only the past N frames and manages occlusion by removing foreground objects and inpainting the occlusion mask using the diffusion model as previously described. By utilizing a limited number of frames (e.g., past N frames), the sliding-window based approach may address issues related to handling occlusions when tracking objects; such an approach may be more efficient and scalable than continuously propagating and tracking objects through an entire sequence of frames.

In certain aspects, inpainting occluded regions provides several advantages over prior approaches. In certain aspects, by explicitly detecting and inpainting occluded regions, the system may be able to maintain consistent object identities through partial and full occlusions. In certain aspects, this approach may lead to more accurate and complete tracking results. Furthermore, in certain aspects, the use of a deep learning model trained on frame data allows for realistic and temporally coherent inpainting results. In certain aspects, the inpainting model's ability to generate plausible object appearances helps to bridge gaps in object trajectories caused by occlusions. By effectively addressing the problem of occlusions, certain aspects of techniques described herein may enable more reliable and advanced applications in areas such as autonomous driving, video surveillance, and augmented reality by maintaining consistent object identities and trajectories, even in the presence of occlusions.

### Example System for Inpainting Occluded Regions

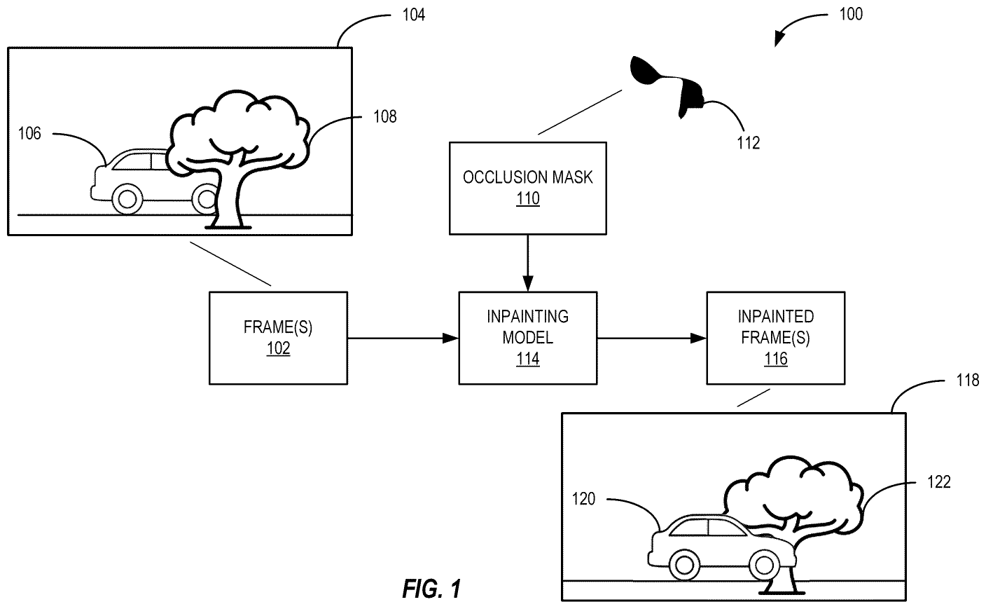

FIG. 1 depicts a block diagram illustrating an example system 100 for inpainting occluded regions in a frame, in accordance with aspects of the present disclosure. In some aspects, the system 100 may include an inpainting model 114 configured to receive inputs including, but not limited to, frame(s) 102 and an occlusion mask 110; the inpainting model 114 may output one or more inpainted frame(s) 116.

In some aspects, the frame(s) 102 may include a frame and/or a sequence of frames from a video, a frame and/or frames from a scene captured by a LIDAR sensor, a fused frame and/or fused frames combining information from multiple sensors, or any other suitable type of frame data. In some aspects, the frame(s) 102 may be provided from various sources, such as video sequences captured by cameras, frames from a scene provided by a LIDAR sensor, etc. In some aspects, fused frames, also known as fused sensor data, may leverage the both LIDAR and cameras, where LIDAR may provide depth information, while one or more image sensors/cameras may provide visual details. In certain aspects, by combining these two modalities, fused frames can improve object detection, tracking, and overall situational awareness in autonomous driving systems.

In certain aspects, the frame(s) 102 may be represented as 3D frames or 3D point clouds. In some aspects, a 3D point cloud may refer to a collection of data points defined in a three-dimensional coordinate system. In some examples, 3D point clouds may be provided from one or more LIDAR sensors, one or more image sensors/cameras, and/or combinations thereof. Such point clouds may be enhanced with color and texture information from camera data, creating a detailed 3D representation of the environment. The frame(s) 102 may contain various objects, such as a first object 106 that is partially occluded by a second object 108. An example frame 104 is shown to illustrate a representative frame from the frame(s) 102.

In certain aspects, the example frame 104 depicts a visual representation of a typical frame from the frame(s) 102 and serves to illustrate example content and example structure of the input frame(s) 102. In the example frame 104, a first object 106 is partially occluded by the second object 108, illustrating an example occlusion problem that the system 100 may address. The first object 106 in the frame(s) 102 may correspond to a detected object of interest, such as a vehicle, pedestrian, or any other relevant object in the scene. In certain aspects, the first object 106 may have one or more occluded regions due to the presence of other objects, like the second object 108 that partially or fully blocks portions of the first object 106 from view.

In certain aspects, the first object 106 may be identified through one or more object detection models applied to the frame(s) 102. Such models may analyze visual and depth information to locate and classify objects within a scene. In certain aspects, the detected first object 106 may have associated properties, such as its bounding box, class label, and position in the 3D space. As previously described, the first object 106 may exhibit partial or complete occlusions due to the presence of other objects in a scene. In some aspects, such occlusions may hinder a model and/or downstream task's perception and understanding of the first object 106. Thus, in some aspects, the system 100 may reconstruct one or more occluded regions and provide a more complete representation of the first object 106.

In certain aspects, the second object 108 represents another object within the frame(s) 102 that may be responsible for occluding the first object 106. In some aspects, the second object 108 may be positioned in front of or overlapping with the first object 106, resulting in partial or complete occlusion of certain regions of the first object 106. In some aspects, the presence of the second object 108 may introduce challenges in accurately perceiving and understanding the first object 106 by one or more models and/or downstream tasks. For example, occlusions caused by the second object 108 may hide visual and geometric information about the first object 106, which may make it more difficult to track, classify, or interact with the first object 106 effectively. In some instances, due in part to the occlusion caused by the second object 108, a downstream task, such as an object tracking task, may assign multiple tracking identifiers to the same tracked object, as the tracked object may be detected and perceived differently when partially occluded than when not occluded.

In certain aspects, the second object 108 may be of the same or different type as the first object 106. For example, in an autonomous driving scenario, the second object 108 could be another vehicle, a pedestrian, or an infrastructure element that obstructs the view of the first object 106, which could also be a vehicle or a pedestrian. The second object 108 may serve as a reference for generating the occlusion mask 110. By identifying the second object 108 and its spatial relationship with the first object 106, the system 100 can determine occluded regions and create an appropriate occlusion mask for inpainting.

In certain aspects, to identify the occluded regions in a point cloud, the density of points in the point cloud corresponding to the first object 106 can be analyzed to determine that a region of the point cloud corresponding to the first object 106 has a density below a threshold, indicating that this region is likely occluded by the second object 108. This region of the point cloud, having a density below the threshold, can then be identified as the first occluded region of the one or more occluded regions in the frame.

In some aspects, to obtain the occlusion mask 110, a point cloud may be projected onto a 2D plane to generate a 2D representation of the first object 106. A region in this 2D representation that corresponds to the first occluded region as determined by the point cloud density analysis can then be identified. This identified region in the 2D representation can be used to create the occlusion mask 110, which may guide the inpainting process performed by the inpainting model 114.

In some aspects, the occlusion mask 110 identifies one or more occluded regions that are to be inpainted. In certain aspects, the occlusion mask 110 may be a binary or multi-valued map that indicates which pixels or regions of an object, such as the first object 106, are occluded by other objects, such as the second object 108. That is, the occlusion mask 110 may act as a guide for the inpainting model 114, directing its attention to the specific areas that may need reconstruction. In some examples, by providing an explicit representation of the occluded regions, the occlusion mask 110 enables the inpainting model 114 to focus on providing the missing information, such as the occluded regions represented by the occlusion mask 110.

In certain aspects, the occlusion mask 110 may be generated using any of various techniques, and may be dependent on the available data and the specific requirements of the system 100. For example, the occlusion mask 110 can be created by comparing depth values between objects in the scene, leveraging semantic segmentation to identify object boundaries, analyzing temporal information from multiple frames to detect occlusions, segmenting one or more objects, and/or utilizing one or more tracking algorithms. An example occlusion mask 112 is provided to illustrate a representative occlusion mask corresponding to the first object 106 in the example frame 104.

In certain aspects, the inpainting model 114 may represent a machine learning model trained to inpaint occluded regions in one or more frames based on an input frame (e.g., frame(s) 102) and an occlusion mask 110. In some aspects, the inpainting model 114 may be a deep learning model, such as a video inpainting diffusion-based model like Lumier, Possum, etc, that inpaints one or more regions of occlusion in a frame. For example, in some aspects, the inpainting model 114 may take frame(s) 102 and the occlusion mask 110 as inputs and generate an inpainted frame 116 (e.g., inpainted frame(s) 116) as output. In some aspects, the inpainting model 114 may utilize information from the surrounding context in the frame(s) 102 and the guidance provided by the occlusion mask 110 to fill in, or inpaint, the occluded regions of the first object 106. That is, the inpainting model 114 may operate by focusing on the occluded regions indicated by the occlusion mask 110 and generating plausible content to fill in those regions based on the surrounding context in the frame(s) 102.

In some aspects, and as will be subsequently described, the inpainting model 114 may be trained using a dataset of frames with (e.g., simulated) occlusions and corresponding ground truth frames to learn how to effectively inpaint occluded regions. During training, the inpainting model 114 may learn to minimize the difference between the inpainted frames and the ground truth frames, enabling it to generate inpainting results. In some aspects, the inpainting model 114 may employ various techniques, such as adversarial training, attention mechanisms, or multi-scale architectures, to capture complex spatial and temporal dependencies that may exist in one or more frames. In some aspects, the inpainting model 114 may incorporate domain-specific knowledge or priors to improve the inpainting quality and consistency.

In some aspects, the output of the inpainting model 114 may include inpainted frame(s) 116, which represent the frame(s) 102 with the occluded regions of the first object 106 inpainted, or reconstructed. For example, the inpainted frame(s) 116 may provide a more complete and accurate representation of a scene by reconstructing the missing portions of the first object 106. That is, the inpainted frame(s) 116 may closely resemble the original frame(s) 102, with the key difference being the filled-in regions corresponding to the previously occluded parts of the first object 106. An example inpainted frame 118 is shown to illustrate a representative frame from the inpainted frame(s) 116.

In the example inpainted frame 118, the previously occluded regions of the first object 106 have been filled in, or successfully reconstructed, resulting in an inpainted object 120. In examples, the inpainted object 120 represents the first object 106 with its occluded regions reconstructed by the inpainting model 114. In some aspects, the inpainted object 120 may encompass the first object 106 or only the portions that were previously occluded, and may be dependent upon the extent of the occlusion and the inpainting process. In some aspects, the inpainted object 120 may allow for a more reliable understanding of the object's shape, size, and position within a scene, which may be relied upon by one or more downstream tasks such as object recognition, tracking, and/or decision-making.

In some aspects, the inpainting of the first object 106 may result in the inpainted object 120 occluding other objects in the scene, such as the second object 122 shown in the example inpainted frame 118. This can occur when the inpainted regions of the first object 106 overlap with the positions of other objects in the frame. Accordingly, in some aspects, inpainting may create multiple versions of the same frame, each with different objects being inpainted.

### Example System for Generating an Occlusion Mask

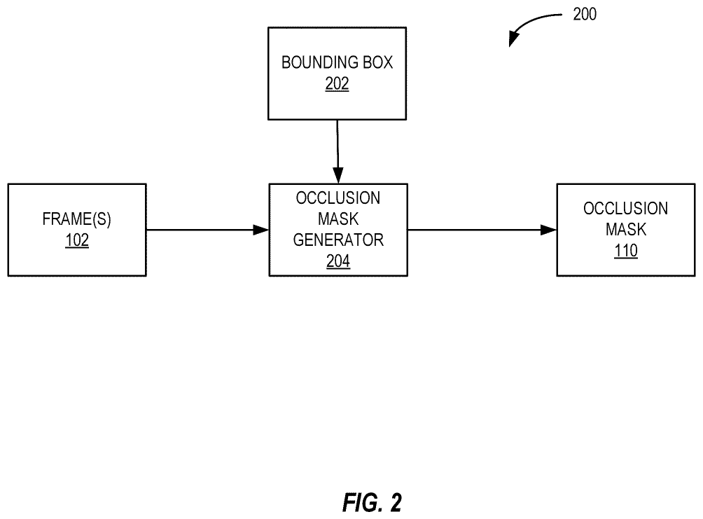

FIG. 2 depicts a block diagram illustrating an example system 200 for generating an occlusion mask, in accordance with aspects of the present disclosure. In some aspects, the system 200 may include an occlusion mask generator 204 configured to receive frame(s) 102 as input and generate an occlusion mask 110. In some aspects, the occlusion mask 110 may be based on a bounding box 202 associated with an occluded object.

In some aspects, the bounding box 202 represents a rectangular region that encloses an object, such as an occluded object, within the frame(s) 102. In some aspects, the bounding box 202 may be determined by an object detection or tracking algorithm that identifies the presence and location of the object, which may include an occluded object, as will be described subsequently herein. In some aspects, the bounding box 202 may be defined by its coordinates, typically represented by the top-left and bottom-right corners or the center coordinates along with the width and height. In certain aspects, these coordinates indicate the spatial extent and position of the object, and in some instances, an occluded object within the frame(s) 102. In some examples, the bounding box 202 may guide the occlusion mask generator 204 to focus on a specific region of interest containing the occluded object. By providing a boundary around an object, the bounding box 202 may isolate an occluded region from the rest of the scene, such that an occlusion mask 110 specific to an occluded region may be generated. In certain aspects, the bounding box 202 may be refined or adjusted based on additional information, such as object class, size, or motion characteristics. Such a refinement process may be used in instances where an initial bounding box may not perfectly align with an occluded object or may include one or more extraneous regions.

In some aspects, the occlusion mask generator 204 is responsible for generating the occlusion mask 110. The occlusion mask 110 may be based on the input frame(s) 102 and/or the bounding box 202. In some aspects, the occlusion mask generator 204 may employ any of various techniques to identify and segment one or more occluded regions within the bounding box 202. For example, the occlusion mask generator 204 may process information within the bounding box 202 to determine which pixels or regions correspond to an object, such as an occluded object. As another example, the occlusion mask generator 204 may process information within the bounding box 202 and analyze pixels within the bounding box to determine a subset of pixels corresponding to an occluded region. Such processing may involve techniques such as pixel-level classification, edge detection, or object segmentation. In certain aspects, the occlusion mask generator 204 may utilize one or more machine learning models, such as convolutional neural networks (CNNs) or semantic segmentation models, to accurately identify and delineate one or more occluded regions. Such machine learning models can be trained on datasets of annotated images to learn the patterns and features associated with occlusions.

In some aspects, the occlusion mask generator 204 may utilize additional cues or information to enhance the accuracy and robustness of the generated occlusion mask 110. These cues may include depth information, motion trajectories, or contextual knowledge about the scene or objects. By leveraging these additional sources of information, the occlusion mask generator 204 may make more informed decisions and handle complex occlusion scenarios more effectively. The output of the occlusion mask generator 204 is the occlusion mask 110, which, as previously described, may be a binary or multi-valued map indicating one or more occluded regions within the bounding box 202. In some aspects, the occlusion mask generator 204 may create the occlusion mask based on the subset of pixels.

In some aspects, the occlusion mask 110 may have a same spatial dimensions as the bounding box 202 and may align with an occluded object within the frame(s) 102. For example, each pixel or region in the occlusion mask 110 may be assigned a value that indicates its occlusion status. For example, pixels with a value of 1 may represent occluded regions, while pixels with a value of 0 may represent non-occluded regions. In certain aspects, the occlusion mask 110 may undergo further post-processing steps, such as morphological operations or smoothing, to refine its boundaries or remove noise or artifacts. These post-processing steps may help in improving the quality and reliability of the occlusion mask 110.

### Example Diagram of an Occlusion Mask Generator

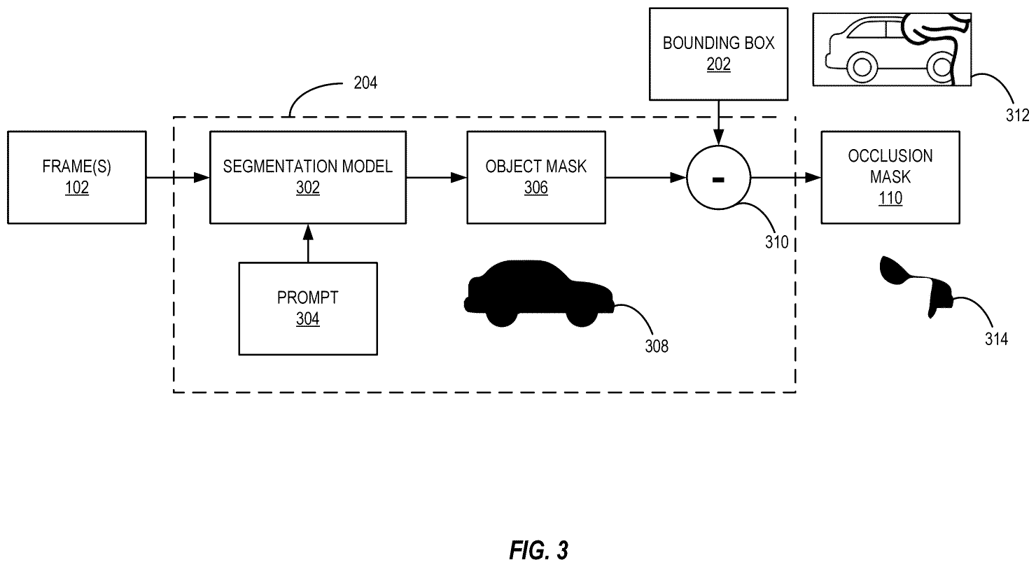

FIG. 3 depicts a block diagram illustrating additional details of an occlusion mask generator 204, in accordance with aspects of the present disclosure. In some aspects, the occlusion mask generator 204 includes a segmentation model 302 that receives frame(s) 102 and a prompt 304 as inputs, and generates an object mask 306. In some aspects, the object mask 306 may be combined with an object within a bounding box 202 using a summation element 310 to produce the occlusion mask 110.

In certain aspects, the segmentation model 302 may be a vocabulary panoptic segmentation model that generates the object mask 306 based on the input frame(s) 102 and the prompt 304. In some aspects, the segmentation model 302 combines the tasks of semantic segmentation and instance segmentation. Semantic segmentation may be directed to the task of assigning a class label to each pixel in the image, while instance segmentation may be directed to the task of identifying and distinguishing individual instances of objects within the same class. In some aspects, the segmentation model 302 may analyze visual features and patterns within the frame(s) 102 and use the prompt 304 to identify and segment the pixels or regions corresponding to the specified object as indicated in the prompt 304. Thus, in certain aspects, the segmentation model may account for spatial context and relationships between objects when generating an object mask 306.

In certain aspects, the segmentation model 302 may employ architectures, such as convolutional neural networks (CNNs) or transformer-based models. Such architectures may be used to capture and learn hierarchical and contextual information from the input frame(s) 102, and may enable accurate segmentation and identification of objects. In some aspects, the segmentation model 302 may be a deep learning model trained on a large dataset of annotated images; as such the segmentation model 302 may undergo a training process based on a diverse dataset that includes examples of objects in various contexts and scenarios. The training process of the segmentation model 302 may involve exposing the segmentation model 302 to a diverse dataset that includes examples of objects in various contexts, poses, and scales. The dataset may cover a wide range of object categories and scenarios to help the model to generalize well with unseen data. In some aspects, and during training, the segmentation model 302 may learn to map the input frame(s) 102 and the prompt 304 to the corresponding object mask 306, minimizing differences between the predicted mask and the ground truth annotations.

In certain aspects, the prompt 304 may be an input to the segmentation model 302 and serves as a textual or semantic description of the object of interest. In some aspects, the prompt 304 may provide a concise and meaningful representation of the object, specifying its category or specific class. For example, the prompt 304 could be “vehicle” or “pedestrian,” depending on the object being tracked. In certain aspects, the prompt 304 guides the segmentation model 302 in generating the object mask 306 corresponding to the specified object. The prompt 304 can help the model focus on the relevant object and distinguish it from other objects or background elements in the frame(s) 102.

In certain aspects, the prompt 304 can take various forms, depending on the specific requirements and context of the occlusion mask generator 204. The prompt 304 may be a single word or a short phrase that accurately describes the object category or class. For example, if the occlusion mask generator 204 is specific to vehicle tracking, the prompt 304 could be “car,” “truck,” or “motorcycle.” In other scenarios, such as person tracking, the prompt 304 could be “person,” “pedestrian,” or “human.” In some aspects, the prompt 304 may be specific enough to distinguish the object of interest from other objects or background elements in the frame(s) 102, while also being general enough to cover variations within the object category. The prompt 304 can be manually provided by a user or automatically generated based on prior knowledge or object tracking information. In certain aspects, the prompt 304 may be derived from a predefined vocabulary or ontology that encompasses the relevant object categories for the specific application domain. Such vocabulary may help to ensure consistency and compatibility between the prompt 304 and the training data used to train the segmentation model 302.

In certain aspects, the object mask 306 is the output of the segmentation model 302 and may represent a binary or multi-valued mask indicating the pixels or regions corresponding to the object specified by the prompt 304. In some aspects, the object mask 306 provides a precise and comprehensive representation of the object, including both the visible and occluded portions. In certain aspects, the object mask 306 is generated based on the segmentation performed by the segmentation model 302. The segmentation model 302 may analyze the visual features and patterns within the frame(s) 102 and assign different values to pixels or regions based on their association with the specified object. As an example, for a binary object mask, pixels belonging to the object may be assigned a value of 1, while non-object pixels are assigned a value of 0. In certain aspects, the object mask 306 may have the same spatial dimensions as the input frame(s) 102, ensuring a direct correspondence between the mask and the original visual data. The object mask 306 captures the shape, contours, and extent of the object, providing a comprehensive representation of its presence in the scene. In certain aspects, the object mask 306 may have the same spatial dimensions as the bounding box 202 and/or may be have the same spatial dimensions as the specified object in the input frame(s) 102, ensuring a direct correspondence between the mask and the visual data.

As previously described, the bounding box 202 may represent the visible or non-occluded portion of the object within the frame(s) 102. In some aspects, the bounding box 202 is obtained through a separate object detection or tracking process, which may identify the location and extent of the object based on its visible features. In certain aspects, the bounding box 202 may be represented by a rectangular region defined by its coordinates, such as the top-left and bottom-right corners, or the center coordinates along with the width and height such that the bounding box 202 can encompass the visible part of the object, and in some instances may excluded occluded regions.

In some aspects, the object mask 306 may be compared with the bounding box 202 such that the occlusion mask generator 204 may identify the occluded regions of the object. More specifically, in certain aspects, the regions of the object mask 306 that do not correspond with an object within the bounding box 202 may be considered occluded, while the regions of the object mask 306 that do correspond with the object in the bounding box 202 may be considered visible. For example, an example object mask 308 generated by the segmentation model 302 may correspond to a vehicle. An example bounding box 202 with example contents from the frame(s) 102 is provided as 312. The portion of the object mask 308 that corresponds to the portion of the object within the bounding box 312 may be non-occluded while the portion of the object mask 308 that does not correspond with a portion of the object within the bounding box 312 may be occluded.

In some aspects, the summation element 310, symbolizes the operation performed to combine the object mask 306 and the bounding box 202 to generate the occlusion mask 110. In some aspects, the summation element 310 indicates a subtraction operation, where the visible portion of the object (i.e., the intersection between the object mask 306 and the bounding box 202) is subtracted from the object mask 306. In some aspects, the summation element 310 may isolate the occluded regions of the object by removing the visible portion from the object mask 306. By subtracting the intersection of the object mask 306 and the bounding box 202 from the object mask 306 itself, the resulting occlusion mask 110 contains only the occluded regions of the object. In certain aspects, the summation element 310 may be implemented using various mathematical or logical operations, depending on the specific representation of the object mask 306 and the bounding box 202.

For example, as previously described, the example object mask 308 is a visual illustration of the object mask 306 generated by the segmentation model 302. The object mask 308 provides a graphical representation of the object's spatial extent within the frame(s) 102, including both the visible and occluded portions. In some aspects, the example object mask 308 may be a binary image, where white pixels (value of 1) represent the object, and black pixels (value of 0) represent the background or non-object regions. In some aspects, and as depicted in FIG. 3, white pixels (value of 1) may represent the background or non-object regions and black pixels (value of 0) may represent the object. The color scheme used in the visual representation of the object mask 308 may vary depending on a specific implementation or choice of visualization. The shape and contours of the white region in the example object mask 308 correspond to the boundaries of the object, encompassing both the visible and occluded parts.

The example occlusion mask 314 is a visual illustration of the occlusion mask 110 generated by the occlusion mask generator 204. The example occlusion mask 314 provides a graphical representation of the occluded region(s) of the object, excluding the visible portions. In some aspects, the example occlusion mask 314 may be a binary image, where white pixels (value of 1) represent the occluded regions, and black pixels (value of 0) represent the non-occluded or background regions. In some aspects, and as depicted in FIG. 3, white pixels (value of 1) may represent the non-occluded or background regions and black pixels (value of 0) may represent the occluded regions. The color scheme used in the visual representation of the occlusion mask 314 may vary depending on a specific implementation or choice of visualization. The shape and contours of the white region in the example occlusion mask 314 correspond to the boundaries of the occluded parts of the object.

### Example Diagram of an Occlusion Mask Generator

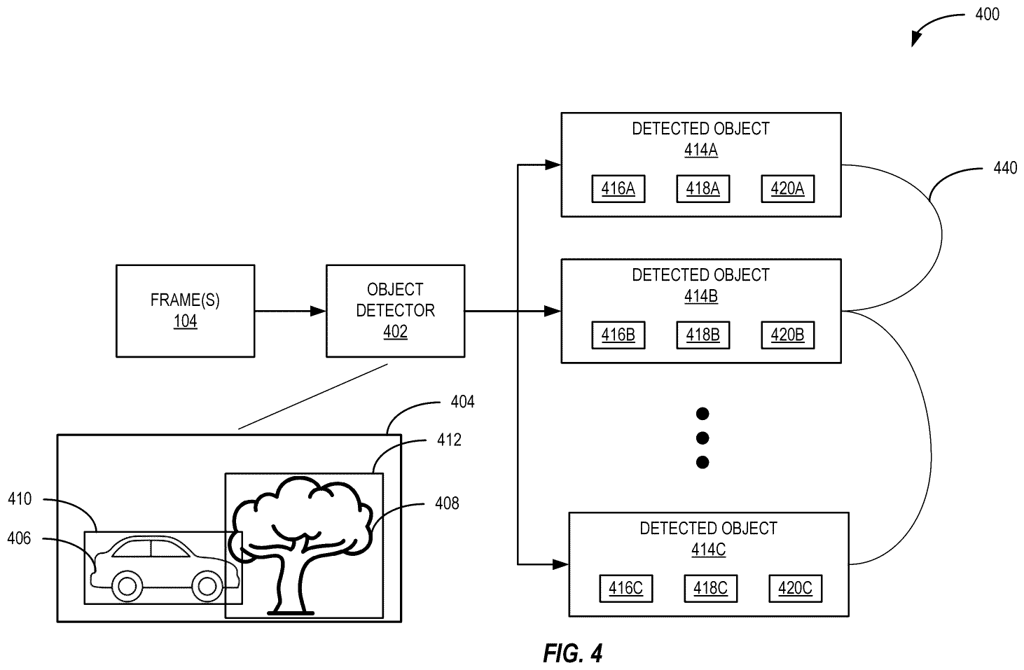

FIG. 4 depicts a block diagram illustrating an example object detection and tracking system 400 for processing one or more frame(s) and generating tracklets, where a tracklet may refer to a temporal sequence of detections associated with an object over multiple frames, in accordance with aspects of the present disclosure. In some aspects, the detected objects may be utilized by an inpainting model 114 (FIG. 1) as will be subsequently described. In some aspects, the system 400 may include an object detector 402 configured to receive frame(s) 102 as input and output detected objects 414A-414C with associated information such as object identifiers 416A-416C, locations 418A-418C, and bounding boxes 420A-420C. In some aspects, the detected objects and their associated information may be used to generate tracklets 440, which may be used to track objects across multiple frames.

In some aspects, the object detector 402 may analyze one or more input frame(s) 102 and identify objects of interest within each frame. In some aspects, the object detector 402 may employ various computer vision techniques, such as deep learning-based object detection models, to locate and classify objects in the frame(s) 102. In certain aspects, the object detector 402 may employ various techniques to improve its performance, such as anchor boxes or feature pyramid networks. Such techniques can enable more efficient scanning of frames at different scales and aspect ratios, enabling more accurate detection of objects with varying sizes and shapes. In some aspects, the object detector 402 may process each frame individually, processing content to detect the presence of relevant objects. In some aspects, the object detector 402 may utilize pre-trained models tailored to the specific domain or application, such as autonomous driving or surveillance systems.

In some aspects, an example frame 404 represents a single frame from the input frame(s) 102 that is being processed by the object detector 402. In some aspects, the example frame 404 may contain multiple objects of interest, such as the first object 406 and a second object 408, which are to be detected and tracked by the object detection and tracking system 400. The example frame 404 provides a visual illustration of the input data that the object detector 402 can operate on. In some aspects, the example frame 404 depicts a captured scene at a particular instant in time, providing a snapshot of the objects and their spatial arrangement within the frame 404. The example frame 404 may be part of a larger sequence of frames, allowing for temporal analysis and tracking of objects across time.

In certain aspects, the first object 406 and the second object 408 represent two distinct objects identified within the example frame 404. In certain aspects, these objects may be of particular interest to the system 400, depending on the specific application or domain. In some aspects, the first object 406 and the second object 408 may be detected by the object detector 402, which analyzes their visual features, such as shape, texture, and color, to determine their presence and location within the frame. These objects may belong to different categories or classes, such as vehicles, pedestrians, or other relevant entities in the context of the application.

In some aspects, the first object bounding box 410 and the second object bounding box 412 are visual representations of the spatial extents of the first object 406 and the second object 408, respectively, within the example frame 404. In some aspects, these bounding boxes may be generated by the object detector 402 to localize the detected objects. In some aspects, the bounding boxes 410 and 412 may be rectangular regions that tightly enclose the detected objects, defining their boundaries within the frame. The bounding boxes may serve as a compact and efficient way to represent the location and size of the objects, facilitating further processing and analysis.

In some aspects, the dimensions and coordinates of the bounding boxes 410 and 412 may be expressed in terms of pixel values or normalized coordinates relative to the frame size. These bounding boxes may enable the system 400 to track the objects across multiple frames by establishing correspondences between detections in consecutive frames based on their spatial proximity and other relevant criteria.

In some aspects, the detected objects 414A-414C represent the output of the object detector 402, which has successfully identified and localized objects within the example frame 404. In certain aspects, each detected object (414A, 414B, 414C) may correspond to a distinct object instance found in the frame, such as the first object 406 or the second object 408. The detected objects 414A-414C may include information about the objects, including their visual characteristics, spatial locations, and potentially other attributes such as class labels or confidence scores. This information may be used in subsequent stages of the system 400, such as object tracking and analysis.

The number of detected objects may vary depending on the complexity of the scene and the performance of the object detector 402. In some cases, the object detector 402 may identify multiple objects of the same or different types within a single frame, providing a comprehensive understanding of the objects present in the scene. Each detected object 414A-414C may include an object identifier 416A-416C, which may be a unique label assigned to each detected object (414A, 414B, 414C) by the system 400. In some aspects, these identifiers serve as a means to distinguish and track individual objects across multiple frames.

The object identifiers 416A-416C may be generated using various techniques, such as assigning sequential numbers or using more sophisticated methods like generating unique hash codes based on the object's visual features or spatial information. These identifiers may enable the system 400 to establish object correspondences and maintain consistent tracking over time. In certain aspects, by associating each detected object with a unique identifier, the system 400 may track the movement, behavior, and interactions of individual objects across frames. This information may be used to process temporal dynamics of the scene and perform higher-level analysis tasks, such as trajectory prediction or anomaly detection.

In certain aspects, each detected object 414A-414C may include location information 418A-418C representing the spatial positions of the detected objects (414A, 414B, 414C) within the example frame 404. In certain aspects, these locations specify the coordinates of the objects in the frame, providing information about their placement. The locations 418A-418C may be expressed using various coordinate systems, such as pixel coordinates or normalized coordinates relative to the frame dimensions. In some aspects, the locations 418A-418C capture the x and y positions (an in some instances, z positions) of the objects, enabling the system 400 to track their movements and analyze their spatial relationships. That is, in certain aspects, the locations 418A-418C serve as a foundation for tracking objects across frames and understanding their spatial dynamics within the scene.

In certain aspects, the detected objects 414A-414C may include one or more bounding boxes 420A-420C, which may correspond to visual representations of the spatial extents of the detected objects (414A, 414B, 414C) within the example frame. In some aspects, these bounding boxes are similar to the first object bounding box 410 and the second object bounding box 412, but they may be associated with the specific detected objects. In certain aspects, the bounding boxes 420A-420C may provide a compact and standardized way to represent the size and location of the detected objects. The bounding boxes 420A-420C may be rectangular regions that tightly enclose the objects, defining their boundaries within the frame. The dimensions and coordinates of the bounding boxes may be expressed in terms of pixel values or normalized coordinates.

In some aspects, the bounding boxes 420A-420C serve multiple purposes in the system 400. For example, the bounding boxes 420A-420C may enable the tracking of objects across frames by establishing correspondences between detections based on their spatial proximity and overlap. Additionally, the bounding boxes may facilitate further analysis and processing of the objects, such as extracting visual features, applying object-specific algorithms, performing spatial reasoning, and performing inpainting by the inpainting model 114.

In some aspects, one or more tracklets 440, representing a temporal sequence of detections associated with an object over multiple frames may be generated. In some examples, the one or more tracklets 440 may be generated by a tracking module as will be described subsequently herein. In some aspects, the tracklet 440 may be generated by the object detector 402 by linking the detected objects (414A, 414B, 414C) across consecutive frames based on their object identifiers (416A, 416B, 416C), locations (418A, 418B, 418C), and/or bounding boxes (420A, 420B, 420C). In certain aspects, the tracklet 440 may capture the movement and behavior of an object over time, providing a representation of its trajectory within a scene. In some aspects, the tracklet 440 may include a series of object detections, each associated with a specific frame, allowing the object detector 402 and/or a tracking module to analyze the object's motion, speed, and direction.

In some aspects, the tracklet 440 may also incorporate additional information, such as object attributes, motion parameters, or uncertainty estimates, to provide a representation of the object's behavior over time. This information can be leveraged by downstream modules for more advanced analysis and decision-making tasks.

### Example System for Object Tracking & Inpainting

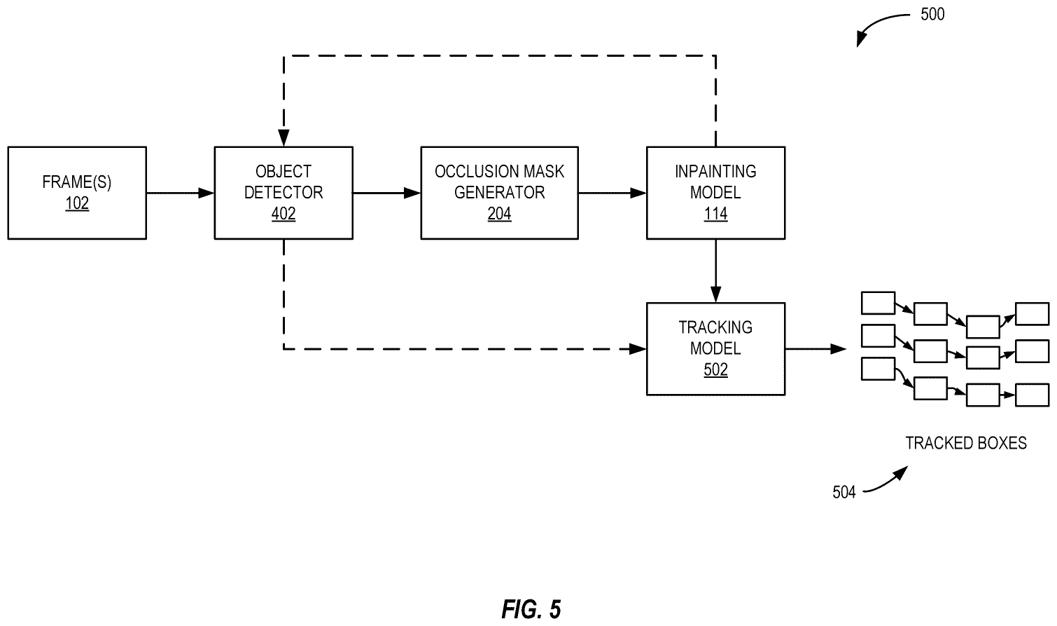

FIG. 5 depicts a block diagram illustrating an example system 500 for object tracking and inpainting, in accordance with aspects of the present disclosure. In some aspects, the system 500 may include an object detector 402, an occlusion mask generator 204, an inpainting model 114, and a tracking model 502. In some aspects, the system 500 takes frame(s) 102 as input and outputs tracked boxes 504 representing the tracked objects in the frame(s) 102.

In certain aspects, the object detector 402 may detect and localize objects within the input frame(s) 102. In some aspects, the object detector 402 may provide one or more detected objects to the tracking model 502. The tracking model 502 may be responsible for tracking the detected and inpainted objects across multiple frames in a frame sequence. In some aspects, the tracking model 502 may take the output of the object detector 402 and/or the inpainting model 114, as input and assigns unique identifiers or labels to each object to maintain their identity throughout the tracking process.

In some aspects, the tracking model 502 may utilize one or more tracking algorithms, such as but not limited to, Kalman filters, particle filters, or deep learning-based approaches, to estimate the motion and trajectory of the objects over time. The tracking model 502 may analyze the appearance, motion, and spatial relationships of the objects across consecutive frames to establish correspondences and maintain consistent object identities. In some aspects, the tracking model 502 may leverage the inpainted objects provided by the inpainting model 114 to improve the robustness and accuracy of the tracking process. In some aspects, the inpainted regions may provide additional visual cues and reduce the impact of occlusions on tracking performance, enabling the tracking model 502 to maintain more stable and reliable object trajectories.

In certain aspects, the output of the object detector 402 may be provided to the occlusion mask generator 204 to generate an occlusion mask for one or more objects in the frame(s) 102. In some aspects, the occlusion mask provided by the occlusion mask generator 204 may be provided to the inpainting model 114 such that an occluded region associated with a detected object can be inpainted. In some examples, the frame(s) including the inpainted or reconstructed object may be provided to the object detector 402 and/or the tracking model 502. Accordingly, in certain aspects, the object detector 402 may subsequently redetect the object and provide the detected to object to the tracking model 502.

In certain aspects, the tracking model 502 may employ techniques such as motion prediction, appearance modeling, or contextual information to enhance the tracking accuracy and handle challenging scenarios. The tracking model 502 may also incorporate one or more mechanisms to handle object entrances, exits, and re-identification to maintain consistent object identities across different frames or even across different camera views. In some aspects, the tracking model 502 may continuously update the positions and velocities of the tracked objects based on the observed visual information and the predicted motion patterns. In some aspects, the tacking model 502 may generate the tracked boxes 504, which may represent the current locations and extents of the objects in each frame, along with their assigned unique identifiers.

In some aspects, the tracked boxes 504 may be represented as bounding boxes or regions that encapsulate the tracked objects, along with their assigned unique identifiers or labels. The tracked boxes 504 may contain the spatial coordinates and dimensions of the objects, allowing for their localization within the frame. The unique identifiers associated with each tracked box may enable the system 500 for object tracking and inpainting to maintain object continuity and identity across multiple frames, facilitating tasks such as object tracking, behavior analysis, or event detection.

In some examples, the tracked boxes 504 may be updated in real-time as the objects move and interact within a scene. In certain aspects, the tracked boxes 504 may be further processed or refined based on application-specific requirements. For example, the tracked boxes 504 may be filtered to remove false positives or merged to handle fragmented detections. Additionally, the tracked boxes 504 may be associated with additional metadata, such as object class labels, confidence scores, or motion vectors, to provide more comprehensive information about the tracked objects.

As previously mentioned, the example system 500 may combine object detection, occlusion mask generation, inpainting, and object tracking to handle occlusions and track objects across multiple frames. The frame(s) 102 serve as input to the object detector 402, which may localize objects of interest. The occlusion mask generator 204 may identify occluded regions, and the inpainting model 114 may reconstruct the occluded parts of the objects. The tracking model 502 may then track the inpainted objects, producing the final tracked boxes 504.

### Example Process for Inpainting Occluded Regions

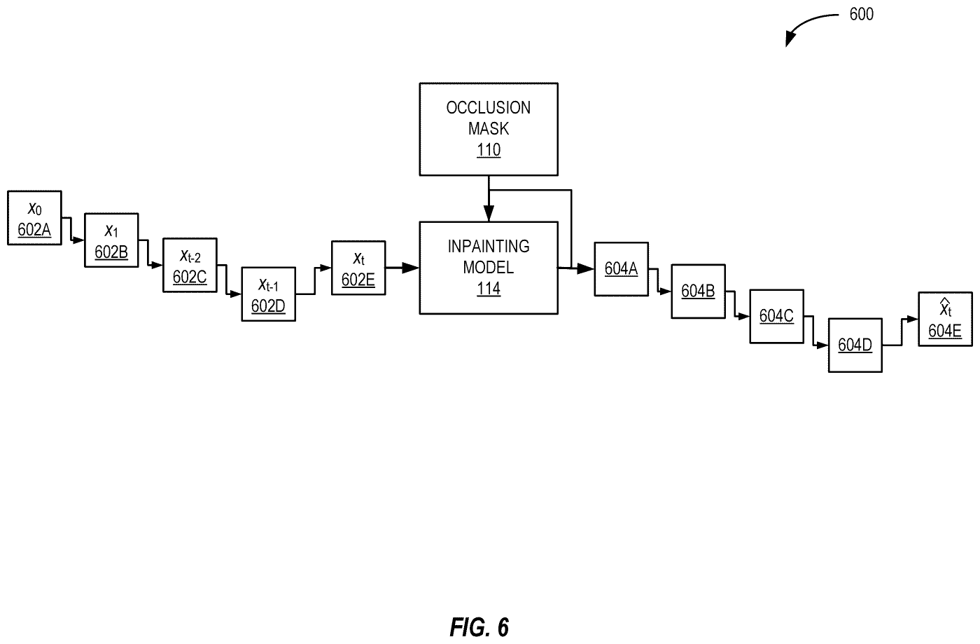

FIG. 6 depicts a block diagram illustrating an example process 600 for inpainting occluded regions in a sequence of frames, in accordance with aspects of the present disclosure. In certain aspects, the process 600 may involve inputting a series of frames corresponding to a tracklet associated with an object into an inpainting model 114 along with a corresponding occlusion mask 110 for the object specific to each frame. In some aspects, at least one frame in the series of frames includes an occluded region of the object. For example, a sliding window comprising frames 602A-602E corresponding to a tracklet for an object may be input into the inpainting model 114. In some examples, one or more frames (e.g., frame 602C and 602D) associated with the tracklet may include the object and one or more occluded regions of the object. In certain aspects, the inpainting model 114 may generate non-occluded frames (e.g., 604C and 604D) corresponding to the previously occluded frames (e.g., 602C and 602D), where the previously occluded regions of the object have been inpainted. While the example frames 602A-602E are shown as individual frames in FIG. 6, they collectively form a single tracklet, which represents the temporal sequence of detections associated with the object being tracked over multiple frames.

The example frames 602A-602E represent a sequence of frames associated with a tracklet, where an object of interest may be partially or fully occluded in one or more of the frames. In some aspects, the example frames 602A-602E may capture the object at different time instances, providing its movement or changes in appearance over time. For example, in the illustrated example, frame 602D may include an occluded object. The object may be partially visible in frame 602D, with certain parts obscured by other objects or elements in the scene. The occlusion in frame 602D may present a challenge for accurately tracking and analyzing the object across the sequence of frames.

In certain aspects, the inpainting model 114 may take the as input, as a sliding window of frames associated with a tracklet (example frames 602A-602E) and an occlusion mask 110 as input and inpaint the occluded regions by leveraging the surrounding visual context and learned patterns from training data. Accordingly, the example frames 604A-604E represent the output of the inpainting model 114, where the previously occluded regions have been reconstructed. In some aspects, at least some of these frames correspond to the inpainted versions of the example frames 602A-602E. In some aspects, the number of frames in a sliding window of frames may be based on a threshold or may be dynamically determined, for example, being based on the motion of the object.

Continuing with the previous example, frame 604D may correspond to the inpainted version of frame 602D. The inpainting model 114 may have reconstructed the occluded parts of the object in frame 604D, resulting in a complete and unobstructed view of the object. The inpainted frame 604D may maintain visual consistency with the surrounding context and may preserve the object's appearance and motion.

In certain aspects, some of the inpainted frames, such as frame 604D, may be fed back into the inpainting model 114 to further refine the inpainting results. This iterative feedback loop allows the inpainting model 114 to leverage the previously inpainted frames as additional context, potentially improving the quality and coherence of the final output.

By generating the example frames 604A-604E without occlusions, the process 600 enables more accurate and reliable tracking and analysis of objects across the sequence of frames. In certain aspects, the inpainted frames may provide a clearer representation of the objects, facilitating tasks such as object recognition, motion estimation, behavior understanding, and object tracking.

### Example System for Training an Inpainting Model

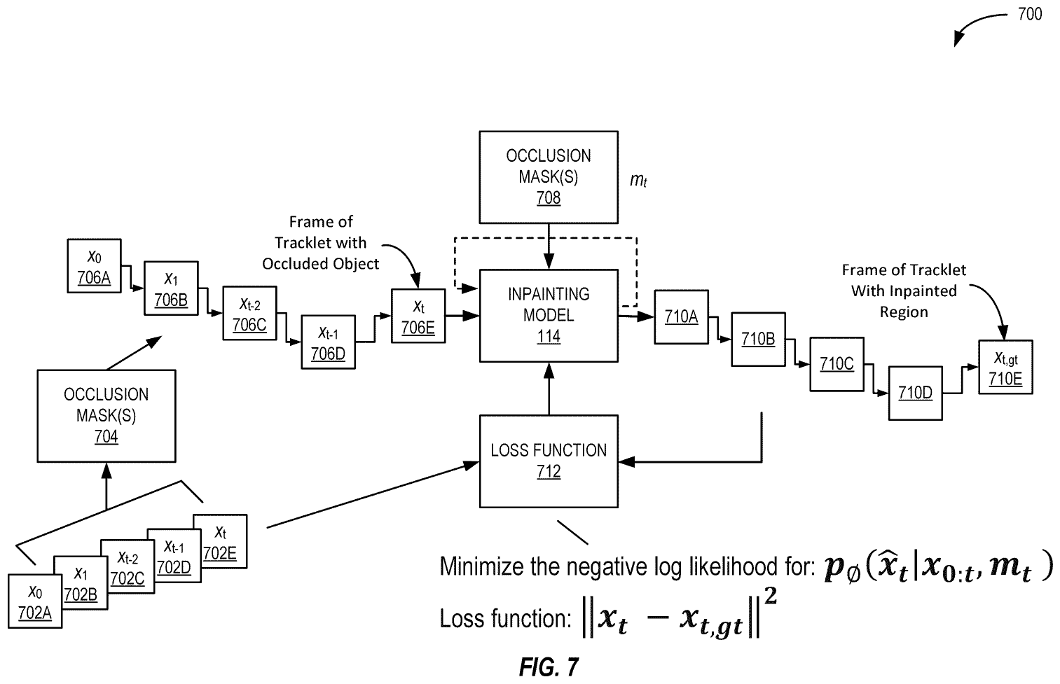

FIG. 7 depicts a block diagram illustrating an example system 700 for training an inpainting model using a loss function, in accordance with aspects of the present disclosure. In some aspects, the system 700 may include an inpainting model 114 configured to receive a series of training frames 706A-706E corresponding to a tracklet, where at least one frame (e.g., training frame 706E) includes an occluded object, and an occlusion mask 708 as inputs. The inpainting model 114 may generate a frame 710E, where the previously occluded region in a training frame 706E has been inpainted. The system 700 may further include a loss function 712 that measures the difference between the one or more of the generated frames 710A-710E and the corresponding ground truth frames 702A-702E to update one or more training parameters of the inpainting model 114 during training.

In certain aspects, the example frames 702A-702E may represent a tracklet of a known object trajectory within a sequence of frames. In some aspects, these frames 702A-702E may capture the object of interest at different time steps. In some aspects, the frames 702A-702E may depict objects having no occlusions. In certain aspects, the frames 702A-702E may serve as a basis for generating training data. An occlusion 704, such as an occlusion mask, may be added to at least one of the frames 702A-702E to generate training frames 706A-706E. In the example shown in FIG. 7, training frame 706E includes an occluded object. In some aspects, the training frames 706A-706E may be provided to the inpainting model 114 together with a training occlusion mask 708, which may be different from the occlusion 704 and/or a mask used to create the occlusion 704, to obtain a sequence of frames 710A-710E. In the generated frame 710E, the previously occluded region of an object has been inpainted. The inpainting model 114 may learn to generate visually coherent and realistic content for the occluded regions by leveraging the surrounding visual context, learned patterns, and semantic understanding. The inpainting model 114 may work to minimize the difference between a frame that includes an inpainted region (e.g., 710E) and the corresponding ground truth frame (e.g., 702E). In some instances, a tracklet corresponding to one or more frames having an inpainted region (e.g., frames 710A-710E) may be subsequently used as training data.

In some aspects, the original frames 702A-702E may be used as ground truth frames and provided to the loss function 712. The loss function 712 may compare one or more of the frames that includes an inpainted region (e.g., 710E) with the corresponding ground truth frame (e.g., 702E) to measure the difference between them. This difference may then be used to update the training parameters of the inpainting model 114, allowing it to improve its inpainting performance over time. The loss function 712 may compare the pixel values, structural similarities, or other relevant metrics between the generated and ground truth frames. In some aspects, the loss function 712 may provide a measure of how well the inpainting model 114 is performing in reconstructing the occluded regions, with the goal being to minimize the loss value, indicating that the frame with the inpainted region more closely resembles the ground truth frame.

In some aspects, and during training, the loss function 712 may be computed for each batch of input frames, and gradients may be backpropagated through the inpainting model 114 to update its parameters. This iterative process allows the inpainting model 114 to learn and improve its inpainting capabilities over time. The choice of the specific loss function may depend on the desired characteristics of the inpainted frames, such as perceptual quality, spatial consistency, or temporal coherence.

The loss function depicted in FIG. 7, may be configured to minimize the negative log-likelihood of the inpainting model's 114 output given the input frame and occlusion mask. The loss function may operate on a pair of tracklets: an input tracklet associated with at least one frame having a tracked object at least partially occluded (e.g., training frames 706A-706E), and an output tracklet associated with at least one frame having an inpainted region corresponding to the occlusion. The input tracklet may include a sequence of frames x₀ to xₜ, where xₜ is the training frame (706E) with the occlusion mask mₜ applied. The output tracklet may include frames x₀ to x_{t,gt}, where x_{t,gt} represents the frame (710E) without occlusion.

In examples, the loss function 712 may be computed as the negative log-likelihood of the diffusion model's output x_{t,gt} given the input ftame xₜ and occlusion mask mₜ. Mathematically, this can be expressed as minimizing the negative log likelihood for: p_{ø}(\hat{x}∨x_{o:t}, mₜ) , where p_{ø}(\hat{x}ₜ∨x_{o:t}, mₜ) represents the probability distribution learned by the inpainting model 114 for generating the output x_{t,gt} given the occluded input frame xₜ and occlusion mask mₜ. During training, an objective may be to minimize the loss function over a large dataset of masked and non-masked tracklet pairs. By minimizing the negative log-likelihood, the diffusion model learns to generate outputs that closely match the ground truth non-occluded appearances of objects. This training process allows the model to learn effective representations for inpainting occluded regions in video sequences.

The use of the negative log-likelihood loss function may be advantageous for training the inpainting model 114, as it may provide a manner to measure the difference between the model's output and the ground truth, taking into account the probabilistic nature of the diffusion process. In certain aspects, by minimizing this loss, the inpainting model 114 is encouraged to generate outputs that are both visually realistic and consistent with the underlying object appearance and motion patterns. Thus, in certain aspects, by minimizing the negative log-likelihood of the model's output given the input frame and occlusion mask, the model learns to generate plausible and accurate inpainting results, enabling robust object tracking through occlusions.

### Example Artificial Intelligence System for Domain Generalization and Adaptation

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example Artificial Intelligence System for Performing Inpainting

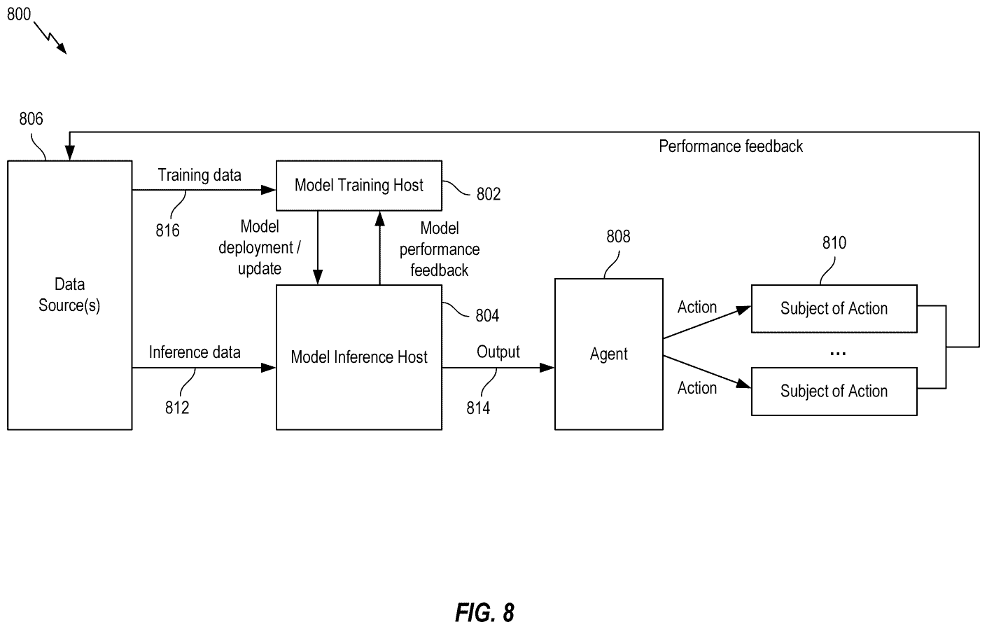

FIG. 8 is a diagram illustrating an example AI architecture 800 that may be used to implement the machine learning models and inpainting techniques described in this disclosure. As illustrated, the architecture 800 includes multiple logical entities, such as a model training host 802 for training the machine learning models for inpainting occlusions in frames, a model inference host 804 for running inference using the trained models for inpainting occlusions in frames, data source(s) 806 providing training and inference data, and an agent 808 that utilizes the models' output. This AI architecture could be used to enable the example disclosed occlusion inpainting techniques in various machine learning applications.

The model inference host 804, in the architecture 800, is configured to run the trained machine learning models based on inference data 812 provided by data source(s) 806. The model inference host 804 may produce an output 814 (e.g., an inpainted frame) based on the inference data 812, that is then provided as input to the agent 808. The model inference host 804 utilizes the occlusion inpainting techniques described in this disclosure to generate an inpainted frame, enabling downstream tasks, such as object detection and/or tracking.

The agent 808 may be an element or entity that utilizes the output of the machine learning models hosted by the model inference host 804. The agent 808 could be a software component, a hardware accelerator, or a system that leverages the inpainted frame produced by the models for various downstream tasks such as image processing, object detection, and/or object tracking.

For example, if the output 814 from the model inference host 804 is a an inpainted frame obtained through occlusion inpainting techniques, the agent 808 may be an object tracking system that uses the inpainted frames to maintain consistent object identities through occlusions.. As another example, if the output 814 is an enhanced video sequence produced by a model trained with occlusion inpainting techniques, the agent 808 could be a video surveillance application, autonomous driving application, etc.

After receiving the output 814 from the model inference host 804, the agent 808 may determine how to utilize it. For instance, if the agent 808 is an object tracking system and the output is an inpainted frame, it may use the inpainted object to update the object's trajectory and maintain its identity. If the agent 808 decides to use the output 814, it may apply it to the subject of the action 810, which represents the data being processed or enhanced. In the object tracking example, the subject of action 810 would be the video sequence. In some cases, the agent 808 and subject of action 810 may be tightly integrated.

The data sources 806 may be configured to collect data used as training data 816 for the model training host 802 to train the inpainting machine learning models. The data sources 806 may also provide inference data 812 to the model inference host 804. This data could come from various entities and may include the subject of action 810. For example, for training an inpainting model, the data sources 806 may collect frames of video sequences having occluded objects and corresponding ground truth frames. The model training host 802 can then monitor the models' performance on this data to determine if retraining or fine-tuning with the occlusion inpainting techniques is necessary to improve accuracy. In some cases, the agent 808 and the subject of action 810 are the same entity.

The data sources 806 may be configured for collecting data that is used as training data 816 for training the machine learning models with occlusion inpainting. The data sources 806 may also provide inference data 812 (also referred to as input data) for feeding the trained models during inference with domain adaptation. In particular, the data sources 806 may collect data relevant to the inpainting task at hand, such as video frames with occluded objects and corresponding occlusion masks. This data may come from various sources, including the subject of action 810, which represents the data being processed by the models. The collected data is provided to the model training host 802 for training and fine-tuning the inpainting model. For example, after the subject of action 810 (e.g., a frame with an occluded object) is processed by the models, the output 814 (e.g., an inpainted frame) may be compared to ground truth data to evaluate the models' performance across domains. If the output 814 is not sufficiently accurate, this performance feedback may be used by the model training host 802 to further train the model using the disclosed occlusion inpainting techniques, aiming to improve inpainting quality. The updated models may then be deployed to the model inference host 804.

In certain aspects, the model training host 802 may be deployed at or with the same or a different entity than that in which the model inference host 804 is deployed. For example, in order to offload model training processing, which can impact the performance of the model inference host 804, the model training host 802 may be deployed at a model server as further described herein. Further, in some cases, training and/or inference may be distributed amongst devices in a decentralized or federated fashion.

In some aspects, machine learning models utilizing occlusion inpainting are deployed at or on a computing device for enhancing the performance of object tracking tasks. More specifically, a model inference host, such as model inference host 804 in FIG. 8, may be deployed at or on the computing device for running the occlusion inpainting model to refine reconstruct occluded objects and improve tracking accuracy.

In some other aspects, inpainting machine learning models are deployed at or on an embedded system or mobile device for enabling efficient on-device inference. More specifically, a model inference host, such as model inference host 804 in FIG. 8, may be deployed at or on the embedded system or mobile device for running the models to obtain high-quality inpainted frames while meeting resource constraints.

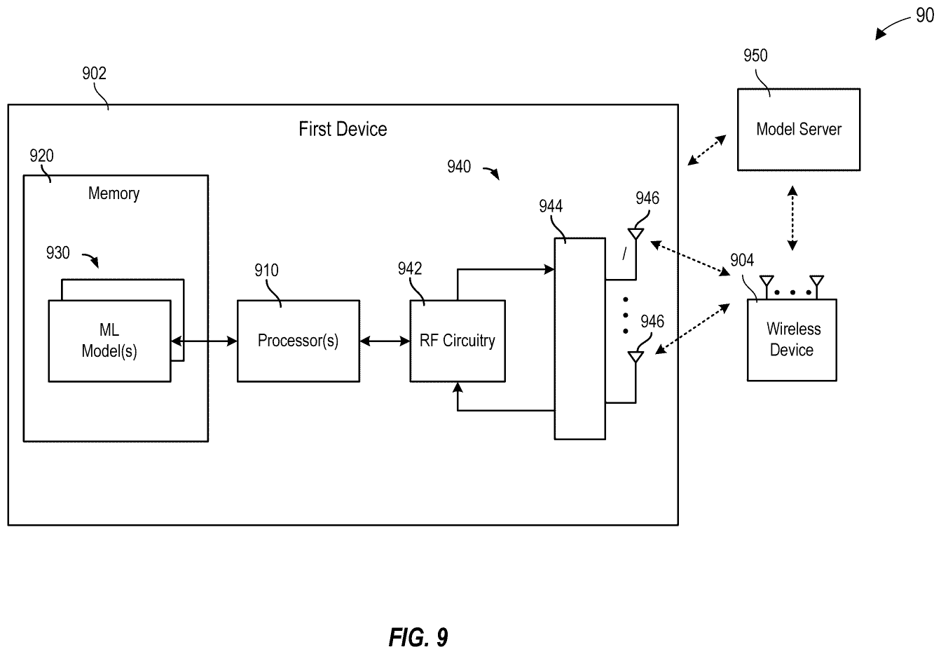

FIG. 9 illustrates an example AI architecture 900 of a first computing device 902 that is in communication with a second computing device 904. The first computing device 902 may be a server or cloud computing platform as described herein with respect to FIG. 8. Similarly, the second computing device 904 may be an embedded system or mobile device as described herein with respect to FIG. 8. Note that the AI architecture of the first computing device 902 may be applied to the second computing device 904.

The first computing device 902 may be, or may include, a chip, system on chip (SoC), a system in package (SiP), chipset, package or device that includes one or more processors, processing blocks or processing elements (collectively “the processor 910”) and one or more memory blocks or elements (collectively “the memory 920”).

As an example, in a model inference mode, the processor 910 may transform input data (e.g., video frames, occlusion masks) into a format suitable for the inpainting models. The processor 910 may then run the models on the formatted input data to generate an inpainted frame. The processor 910 may be coupled to a transceiver 940 for transmitting the output inpainted frame to and/or receiving input data from one or more connected devices 946. The transceiver 940 includes interface circuitry 942 and 944 for converting between the digital signals of the processor and any transmission protocol used by the connected devices 946. The connected devices 946 may be sensors, cameras, displays, or storage that provide input to or consume the output from the models.

When receiving input data via the connected devices 946 (e.g., from the second computing device 904), the transceiver interface circuitry 942 and 944 may convert the received signals to a baseband frequency and then to digital signals for processing by the processor 910. The processor 910 may format the digital input signals and feed them into the inpainting model for inference.

One or more ML models 930 may be stored in the memory 920 and accessible to the processor(s) 910. In certain cases, different ML models 930 with different characteristics may be stored in the memory 920, and a particular ML model 930 may be selected based on its characteristics and/or application as well as characteristics and/or conditions of first computing device 902 (e.g., a power state, a mobility state, a battery reserve, a temperature, etc.). For example, the ML models 930 may have different inference data and output pairings (e.g., different types of inference data produce different types of output), different levels of accuracies (e.g., 80%, 90%, or 95% accurate) associated with the inpainted frames (e.g., the output 814 of FIG. 8), different latencies (e.g., processing times of less than 10 ms, 100 ms, or 1 second) associated with producing the inpainted frames, different ML model sizes (e.g., file sizes), different coefficients or weights, etc.

The processor 910 may use the ML model 930 to produce output data (e.g., the output 814 of FIG. 8) based on input data (e.g., the inference data 812 of FIG. 8), for example, as described herein with respect to the inference host 804 of FIG. 8. The ML model 930 may be used to perform any of various AI-enhanced tasks, such as those listed above.

As an example, the ML model 930 may take a video frame with an occluded object and a corresponding occlusion mask as input to predict an inpainted frame using one or more example occlusion inpainting techniques previously described. The input data may include, for example, frames from a video sequence where an object of interest is partially or fully occluded, along with occlusion masks indicating the occluded regions. The output data may include, for example, an inpainted frame where the previously occluded regions of the object have been reconstructed, which is obtained by applying the occlusion inpainting model'. In certain aspects, the output inpainted frame may be considered a “virtual” result in that it is not directly captured by a camera but rather inferred by the model based on the surrounding context and learned patterns. In other cases, the output inpainted frame may correspond to a view of the object that is measurable in principle but not directly captured by the camera due to occlusion. Note that other input data and/or output data may be used in addition to or instead of the examples described herein, depending on the specific inpainting task and the available data.

In certain aspects, a model server 950 may perform any of various ML model lifecycle management (LCM) tasks for the first computing device 902 and/or the second computing device 904. The model server 950 may operate as the model training host 802 and update the ML model 930 using training data from multiple domains to enable domain generalization. In some cases, the model server 950 may operate as the data source 806 to collect and host training data, inference data, and/or performance feedback associated with an ML model 930 across different domains. In certain aspects, the model server 950 may host various types and/or versions of the ML models 930 for the first computing device 902 and/or the second computing device 904 to download.

In some cases, the model server 950 may monitor and evaluate the performance of the ML model 930 that utilizes occlusion inpainting techniques to trigger one or more lifecycle management (LCM) tasks. For example, the model server 950 may determine whether to activate or deactivate the use of a particular inpainting model at the first computing device 902 and/or the second computing device 904, based on factors such as the accuracy requirements, computational budget, and energy constraints of each device. The model server 950 may then provide instructions to the respective devices to manage their model usage accordingly. In some cases, the model server 950 may determine whether to switch to a different variant of the inpainting ML model 930 at the first computing device 902 and/or the second computing device 904, based on changes in the operating conditions or performance objectives. For instance, the model server may instruct a device to switch from a complex model with high inpainting quality to a simpler model with lower latency when the battery level falls below a threshold. In yet further examples, the model server 950 may act as a central coordinator for collaborative learning of inpainting models across multiple devices, using techniques such as federated learning to train a global model from locally-computed updates while preserving data privacy.

### Example Artificial Intelligence Model

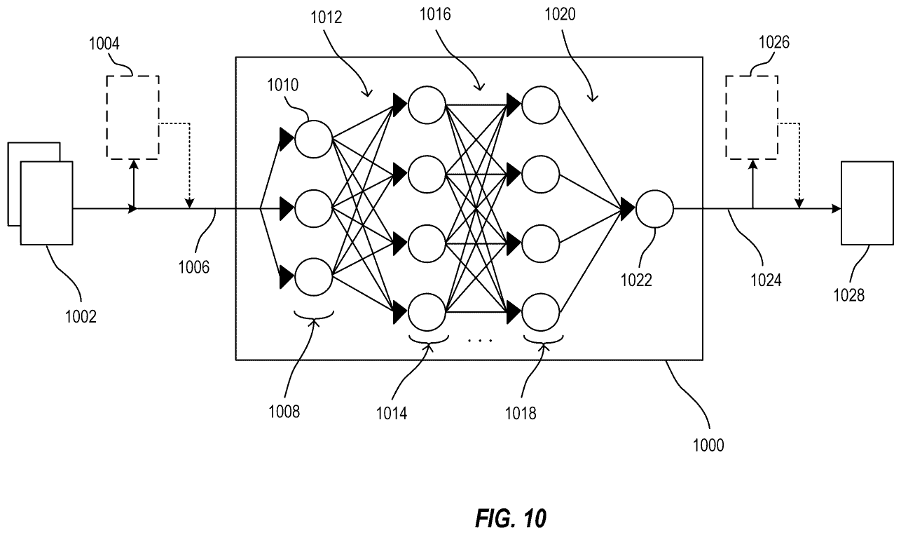

FIG. 10 is an illustrative block diagram of an example artificial neural network (ANN) 1000 that can be used to implement the domain generalization and adaptation techniques described in this disclosure.

ANN 1000 may receive input data 1006 which may include one or more bits of data 1002, pre-processed data output from pre-processor 1004 (optional), or some combination thereof. Here, data 1002 may include training data from multiple domains for domain generalization, inference data from a specific domain for domain adaptation, or the like, e.g., depending on the stage of development and/or deployment of ANN 1000. Pre-processor 1004 may be included within ANN 1000 in some other implementations. Pre-processor 1004 may, for example, process all or a portion of data 1002 which may result in some of data 1002 being changed, replaced, deleted, etc. In some implementations, pre-processor 1004 may add additional data to data 1002, such as domain-specific information or metadata.

ANN 1000 includes at least one first layer 1008 of artificial neurons 1010 (e.g., perceptrons) to process input data 1006 and provide resulting first layer output data via edges 1012 to at least a portion of at least one second layer 1014. Second layer 1014 processes data received via edges 1012 and provides second layer output data via edges 1016 to at least a portion of at least one third layer 1018. Third layer 1018 processes data received via edges 1016 and provides third layer output data via edges 1020 to at least a portion of a final layer 1022 including one or more neurons to provide output data 1024. All or part of output data 1024 may be further processed in some manner by (optional) post-processor 1026. Thus, in certain examples, ANN 1000 may provide output data 1028 that is based on output data 1024, post-processed data output from post-processor 1026, or some combination thereof. Post-processor 1026 may be included within ANN 1000 in some other implementations. Post-processor 1026 may, for example, process all or a portion of output data 1024 which may result in output data 1028 being different, at least in part, to output data 1024, e.g., as result of data being changed, replaced, deleted, etc. In some implementations, post-processor 1026 may be configured to add additional data to output data 1024, such as domain-specific post-processing or adaptation. In this example, second layer 1014 and third layer 1018 represent intermediate or hidden layers that may be arranged in a hierarchical or other like structure. Although not explicitly shown, there may be one or more further intermediate layers between the second layer 1014 and the third layer 1018.

The structure and training of artificial neurons 1010 in the various layers may be tailored to specific requirements of an application, such as domain generalization and adaptation for estimation tasks. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 812 in FIG. 8) across different domains. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 1000 and a number of layers and a number of artificial neurons in each layer, as well as selecting activation functions, a loss function, training processes, etc., to enable domain generalization and adaptation. Once an initial model has been designed, training of the model may be conducted using training data from multiple domains. Training data may include one or more datasets within which ANN 1000 may detect, determine, identify or ascertain patterns that are consistent across domains. Training data may represent various types of information, including written, visual, audio, environmental context, operational properties, etc., from different domains. During training, parameters of artificial neurons 1010 may be changed, such as to minimize or otherwise reduce a loss function or a cost function that measures the model's performance across domains. A training process may be repeated multiple times to fine-tune ANN 1000 with each iteration to improve its domain generalization capability.

Various ANN model structures are available for consideration in the context of domain generalization and adaptation. For example, in a feedforward ANN structure each artificial neuron 1010 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression in a domain-agnostic manner.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and adaptation include fully connected neural networks (FCNNs) and long short-term memory (LSTM) networks.

ANN 1000 or other ML models may be implemented in various types of processing circuits along with memory and applicable instructions therein, for example, as described herein with respect to FIGS. 8 and 9. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform domain generalization and adaptation.

### Aspects of Artificial Intelligence Model Training

There are a variety of model training techniques and processes that may be used prior to, or at some point following, deployment of an ML model, such as ANN 1000 of FIG. 10, to enable domain generalization and adaptation.

For example, training data may include ground truth frames without occlusions, as well as corresponding frames with synthetically generated or real-world occlusions and occlusion masks. This data can be used to train the model to accurately inpaint occluded regions and reconstruct the appearance of occluded objects. In certain instances, the training data may originate from video sequences captured by cameras on user devices (e.g., smartphones, vehicles), dedicated data collection setups (e.g., multi-camera rigs, controlled environments), or public datasets. In some cases, the training data may be aggregated from multiple sources to cover a wide range of occlusion scenarios and improve model generalization. For example, crowdsourcing platforms or online databases may be leveraged to gather diverse examples of occluded objects for training inpainting models. In another example, training data may be generated synthetically by overlaying virtual objects on real-world scenes or using computer graphics techniques to simulate occlusions. The training data collection process can be performed offline, resulting in a static dataset for batch training, or online, where new samples are continuously incorporated into the model training pipeline. For example, a mobile device may periodically upload new training samples of occluded objects encountered during its operation to a server, which then fine-tunes the inpainting model using online learning techniques. For offline training, data collection and model updates can occur at a central location (e.g., a datacenter) or be distributed across multiple nodes (e.g., a network of cameras). For online training, the model may be adapted locally on each device or by a remote server that receives streaming data from the devices.

In certain instances, all or part of the training data may be shared within a communication system, or even shared (or obtained from) outside of the communication system.

Once an ML model has been trained with training data from multiple domains, its performance may be evaluated on held-out test data from both seen and unseen domains. In some scenarios, evaluation/verification tests may use a validation dataset, which may include data not in the training data, to compare the model's performance to baseline or other benchmark information across different domains. If model performance is deemed unsatisfactory, it may be beneficial to fine-tune the model, e.g., by changing its architecture, re-training it on the data with domain-specific adjustments, or using different optimization techniques that promote domain generalization, etc. Once a model's performance is deemed satisfactory across a wide range of domains, the model may be deployed accordingly. In certain instances, a model may be updated in some manner, e.g., all or part of the model may be changed or replaced, or undergo further training with data from new domains, just to name a few examples.

As part of a training process for an ANN, such as ANN 1000 of FIG. 10, parameters affecting the functioning of the artificial neurons and layers may be adjusted to learn domain-invariant representations. For example, backpropagation techniques may be used to train the ANN by iteratively adjusting weights and/or biases of certain artificial neurons associated with errors between a predicted output of the model and a desired output that may be known or otherwise deemed acceptable across different domains. Backpropagation may include a forward pass, a loss function, a backward pass, and a parameter update that may be performed in training iteration. The process may be repeated for a certain number of iterations for each set of training data until the weights of the artificial neurons/layers are adequately tuned to minimize domain-specific biases.

Backpropagation techniques associated with a loss function may measure how well a model is able to predict a desired output for a given input across different domains. An optimization algorithm may be used during a training process to adjust weights and/or biases to reduce or minimize the loss function which should improve the performance of the model on unseen domains. There are a variety of optimization algorithms that may be used along with backpropagation techniques or other training techniques to promote domain generalization. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function that measures cross-domain performance. A mini-batch gradient descent technique, which is a variant of gradient descent, may involve updating weights/biases using a small batch of training data from different domains rather than the entire dataset. A momentum technique may accelerate an optimization process by adding a momentum term to update or otherwise affect certain weights/biases in a domain-agnostic way.

An adaptive learning rate technique may adjust a learning rate of an optimization algorithm associated with one or more characteristics of the training data from different domains. A batch normalization technique may be used to normalize inputs to a model in order to stabilize a training process and potentially improve the performance of the model across domains.

A “dropout” technique may be used to randomly drop out some of the artificial neurons from a model during a training process, e.g., in order to reduce overfitting to specific domains and potentially improve the generalization of the model to unseen domains.

An “early stopping” technique may be used to stop an on-going training process early, such as when a performance of the model using a validation dataset from a different domain starts to degrade.

Another example technique includes data augmentation to generate additional training data by applying domain-specific transformations to all or part of the training information.

A transfer learning technique may be used which involves using a pre-trained model as a starting point for training a new model on a different domain, which may be useful when training data from the new domain is limited or when there are multiple tasks that are related to each other across domains.

A multi-task learning technique may be used which involves training a model to perform multiple tasks simultaneously across different domains to potentially improve the performance of the model on one or more of the tasks in a domain-agnostic way. Hyperparameters or the like may be input and applied during a training process in certain instances to control the degree of domain generalization.

Another example technique that may be useful with regard to an ML model for domain generalization is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model across different domains.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored, while preserving its domain generalization capability.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that utilize occlusion inpainting on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of inpainting tasks such as object removal or occlusion handling, for example, federated learning may be used to improve model performance by allowing it to learn from a wide range of occlusion scenarios and object categories. For instance, an occlusion inpainting model may be trained on data collected from a large number of smartphones or surveillance cameras, each with its own unique environment and types of occluded objects, to improve its robustness and generalization. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the inpainting model achieves satisfactory performance across all participating devices. By enabling collaborative learning while keeping data localized, federated learning allows the development of powerful inpainting models that can leverage diverse datasets without compromising privacy or security.

In some implementations, one or more devices or services may support processes relating to the usage, maintenance, activation, and reporting of machine learning models that utilize occlusion inpainting techniques as described above. In certain instances, all or part of the training data or the trained model may be shared across multiple devices to provide or improve the inpainting capabilities. For example, a smartphone with a depth sensor may share its data with a smartphone having only a single camera, enabling the latter to train an inpainting model. In some cases, signaling mechanisms may be employed to communicate the capabilities and requirements for performing specific functions related to inpainting models, such as the supported input and output formats, the available computational resources, or the ability to collect and share training data. These models may be used to support various applications, such as augmented reality, robotics, autonomous driving, or video processing, where accurate and efficient estimation of quantities like depth, flow, or segmentation is crucial.

### Example Operations for Performing Inpainting

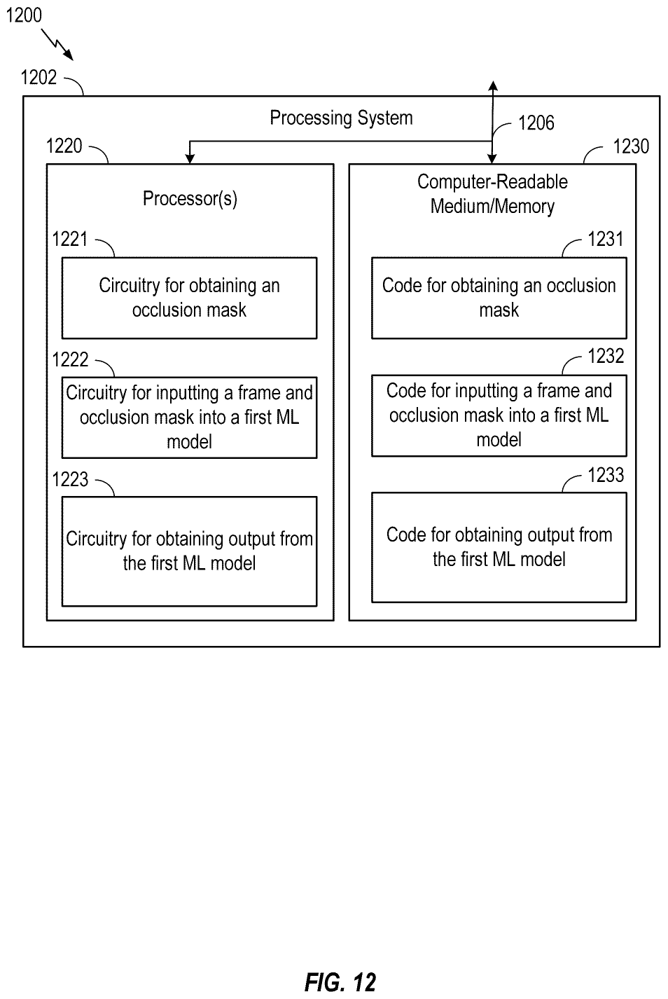

In one aspect, method 1100, or any aspect related to it, may be performed by an apparatus, such as processing system 1200 of FIG. 12, which includes various components operable, configured, or adapted to perform the method 1100.

Method 1100 begins a block 1102 with obtaining an occlusion mask corresponding to a first occluded region of one or more occluded regions in a frame, wherein the first occluded region corresponds to a first object.

Method 1100 then proceeds to block 1104 with inputting the frame and the occlusion mask into a first machine learning (ML) model trained to inpaint the frame.

Method 1100 then proceeds to block 1106 with obtaining as output from the first ML model an inpainted frame that corresponds to the frame with the first object inpainted in the first occluded region.

In certain aspects, obtaining the occlusion mask comprises generating the occlusion mask.

In certain aspects, generating the occlusion mask comprises inputting a sequence of frames comprising the frame into a segmentation model configured to generate the occlusion mask.

In certain aspects, generating the occlusion mask by the segmentation model comprises: identifying a bounding box associated with the first occluded region; analyzing pixels within the bounding box to determine a subset of pixels corresponding to the first occluded region; and creating the occlusion mask based on the subset of pixels.

In certain aspects, the first ML model comprises a diffusion-based inpainting model.

In certain aspects, the first ML model is trained by a process comprising: obtaining a training dataset comprising a plurality of training frames and corresponding ground truth frames; obtaining a plurality of training occlusion masks for the plurality of training frames; inputting into the first ML model the plurality of training frames and the plurality of training occlusion masks to generate inpainted training frames; and updating parameters of the first ML model based on a loss function that measures a difference between the inpainted training frames and the corresponding ground truth frames.

In certain aspects, method 1100 further includes associating the first object with a tracklet, wherein the tracklet comprises a plurality of bounding boxes representing the first object over a plurality of frames; and updating the tracklet based on the inpainted frame.

In certain aspects, method 1100 further includes providing the inpainted frame to an object tracking system for further processing.

In certain aspects, method 1100 further includes obtaining the frame from at least one of an image sensor or a LIDAR sensor.

In certain aspects, the first object is a 3D object represented by a point cloud.

In certain aspects, method 1100 further includes analyzing a density of points in the point cloud; determining that a region of the point cloud corresponding to the first object has a density below a threshold; and identifying the region of the point cloud corresponding to the first object having the density below a predetermined threshold as the first occluded region of the one or more occluded regions in the frame.

In certain aspects, obtaining the occlusion mask, comprises: projecting the point cloud onto a 2D plane to generate a 2D representation of the first object; and identifying a region in the 2D representation corresponding to the first occluded region.

In certain aspects, method 1100 further includes communicating at least one of the frame or the inpainted frame via a modem coupled to one or more antennas.

In certain aspects, the modem and the one or more antennas are integrated into one of a vehicle, an extra-reality device, or a mobile device.

In certain aspects, method 1100 further includes acquiring the frame from at least one image sensor.

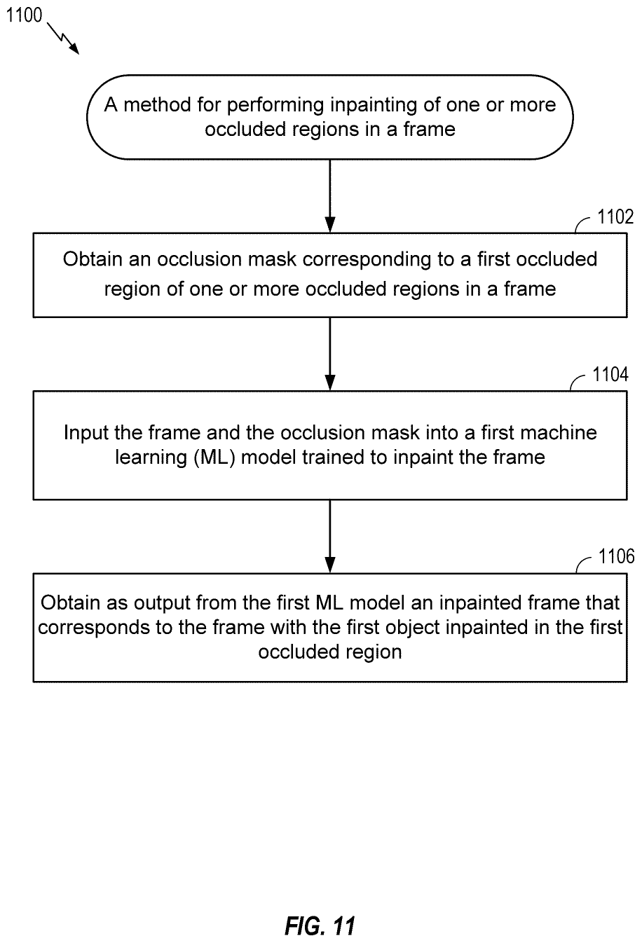

Note that FIG. 11 is just one example of a method, and other methods including fewer, additional, or alternative steps are possible consistent with this disclosure.

### Example Processing System for Performing Inpainting

FIG. 12 depicts aspects of an example processing system 1200.

The processing system 1200 includes a processing system 1202 includes one or more processors 1220. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1100 described with respect to FIG. 11, or any aspect related to it, including any additional steps or sub-steps described in relation to FIG. 11.

In the depicted example, computer-readable medium/memory 1230 stores code (e.g., executable instructions) for obtaining an occlusion mask 1231, code for inputting a frame and occlusion mask into a first ML model 1232, and code for obtaining output from the first ML model 1233. Processing of the code 1231-1233 may enable and cause the processing system 1200 to perform the method 1100 described with respect to FIG. 11, or any aspect related to it.

The one or more processors 1220 include circuitry configured to implement (e.g., execute) the code stored in the computer-readable medium/memory 1230, including circuitry for obtaining an occlusion mask 1221, circuitry for inputting a frame and occlusion mask into a first ML model 1222, and circuitry for obtaining output from the first ML model 1223. Processing with circuitry 1221-1223 may enable and cause the processing system 1200 to perform the method 1100 described with respect to FIG. 11, or any aspect related to it.

### Example Clauses

Implementation examples are described in the following numbered clauses:

Clause 1: A method for performing inpainting of one or more occluded regions in a frame, comprising: obtaining an occlusion mask corresponding to a first occluded region of one or more occluded regions in the frame, wherein the first occluded region corresponds to a first object; inputting the frame and the occlusion mask into a first machine learning (ML) model trained to inpaint the frame; and obtaining as output from the first ML model an inpainted frame that corresponds to the frame with the first object inpainted in the first occluded region.

Clause 2: The method of Clause 1, wherein obtaining the occlusion mask comprises generating the occlusion mask.

Clause 3: The method of Clause 2, wherein generating the occlusion mask comprises inputting a sequence of frames comprising the frame into a segmentation model configured to generate the occlusion mask.

Clause 4: The method of Clause 3, wherein generating the occlusion mask by the segmentation model comprises: identifying a bounding box associated with the first occluded region; analyzing pixels within the bounding box to determine a subset of pixels corresponding to the first occluded region; and creating the occlusion mask based on the subset of pixels.

Clause 5: The method of any one of Clauses 1-4, wherein the first ML model comprises a diffusion-based inpainting model.

Clause 6: The method of any one of Clauses 1-5, wherein the first ML model is trained by a process comprising: obtaining a training dataset comprising a plurality of training frames and corresponding ground truth frames; obtaining a plurality of training occlusion masks for the plurality of training frames; inputting into the first ML model the plurality of training frames and the plurality of training occlusion masks to generate inpainted training frames; and updating parameters of the first ML model based on a loss function that measures a difference between the inpainted training frames and the corresponding ground truth frames.

Clause 7: The method of any one of Clauses 1-6, further comprising: associating the first object with a tracklet, wherein the tracklet comprises a plurality of bounding boxes representing the first object over a plurality of frames; and updating the tracklet based on the inpainted frame.

Clause 8: The method of any one of Clauses 1-7, further comprising providing the inpainted frame to an object tracking system for further processing.

Clause 9: The method of any one of Clauses 1-8, further comprising obtaining the frame from at least one of an image sensor or a LIDAR sensor.

Clause 10: The method of any one of Clauses 1-9, wherein the first object is a 3D object represented by a point cloud.

Clause 11: The method of Clause 10, further comprising: analyzing a density of points in the point cloud; determining that a region of the point cloud corresponding to the first object has a density below a threshold; and identifying the region of the point cloud corresponding to the first object having the density below a predetermined threshold as the first occluded region of the one or more occluded regions in the frame.

Clause 12: The method of Clause 10, wherein obtaining the occlusion mask, comprises: projecting the point cloud onto a 2D plane to generate a 2D representation of the first object; and identifying a region in the 2D representation corresponding to the first occluded region.

Clause 13: The method of any one of Clauses 1-12, further comprising communicating at least one of the frame or the inpainted frame via a modem coupled to one or more antennas.

Clause 14: The method of Clause 13, wherein the modem and the one or more antennas are integrated into one of a vehicle, an extra-reality device, or a mobile device.

Clause 15: The method of any one of Clauses 1-14, further comprising acquiring the frame from at least one image sensor.

Clause 16: One or more apparatuses, comprising: one or more memories comprising executable instructions; and one or more processors configured to execute the executable instructions and cause the one or more apparatuses to perform a method in accordance with any one of clauses 1-15.

Clause 17: One or more apparatuses, comprising: one or more memories; and one or more processors, coupled to the one or more memories, configured to cause the one or more apparatuses to perform a method in accordance with any one of Clauses 1-15.

Clause 18: One or more apparatuses, comprising: one or more memories; and one or more processors, coupled to the one or more memories, configured to perform a method in accordance with any one of Clauses 1-15.

Clause 19: One or more apparatuses, comprising means for performing a method in accordance with any one of Clauses 1-15.

Clause 20: One or more non-transitory computer-readable media comprising executable instructions that, when executed by one or more processors of one or more apparatuses, cause the one or more apparatuses to perform a method in accordance with any one of Clauses 1-15.

Clause 21: One or more computer program products embodied on one or more computer-readable storage media comprising code for performing a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured to perform inpainting of one or more occluded regions in a frame, comprising:
one or more memories configured to store the frame; and
one or more processors, coupled to the one or more memories, configured to:
obtain an occlusion mask corresponding to a first occluded region of the one or more occluded regions in the frame, wherein the first occluded region corresponds to a first object;
input the frame and the occlusion mask into a first machine learning (ML) model trained to inpaint the frame; and
obtain as output from the first ML model an inpainted frame that corresponds to the frame with the first object inpainted in the first occluded region.

2. The apparatus of claim 1, wherein to obtain the occlusion mask comprises to generate the occlusion mask.

3. The apparatus of claim 2, wherein to generate the occlusion mask comprises to input a sequence of frames comprising the frame into a segmentation model configured to generate the occlusion mask.

4. The apparatus of claim 3, wherein the segmentation model is configured to:
identify a bounding box associated with the first occluded region;
analyze pixels within the bounding box to determine a subset of pixels corresponding to the first occluded region; and
create the occlusion mask based on the subset of pixels.

5. The apparatus of claim 1, wherein the first ML model comprises a diffusion-based inpainting model.

6. The apparatus of claim 1, wherein the first ML model is trained by a process comprising to:
obtain a training dataset comprising a plurality of training frames and corresponding ground truth frames;
obtain a plurality of training occlusion masks for the plurality of training frames;
input into the first ML model the plurality of training frames and the plurality of training occlusion masks to generate inpainted training frames; and
update parameters of the first ML model based on a loss function that measures a difference between the inpainted training frames and the corresponding ground truth frames.

7. The apparatus of claim 1, wherein the one or more processors are further configured to:
associate the first object with a tracklet, wherein the tracklet comprises a
plurality of bounding boxes representing the first object over a plurality of frames; and
update the tracklet based on the inpainted frame.

8. The apparatus of claim 1, wherein the one or more processors are further configured to provide the inpainted frame to an object tracking system for further processing.

9. The apparatus of claim 1, further comprising at least one of an image sensor or a LIDAR sensor configured to obtain the frame.

10. The apparatus of claim 1, wherein the first object is a 3D object represented by a point cloud.

11. The apparatus of claim 10, wherein the one or more processors are further configured to:
analyze a density of points in the point cloud;
determine that a region of the point cloud corresponding to the first object has a density below a predetermined threshold; and
identify the region of the point cloud corresponding to the first object having the density below a threshold as the first occluded region of the one or more occluded regions in the frame.

12. The apparatus of claim 10, wherein to obtain the occlusion mask, comprises to:
project the point cloud onto a 2D plane to generate a 2D representation of the first object; and
identify a region in the 2D representation corresponding to the first occluded region.

13. The apparatus of claim 1, further comprising a modem, coupled to one or more antennas, and coupled to the one or more processors, wherein the modem and the one or more antennas are configured to communicate at least one of the frame or the inpainted frame.

14. The apparatus of claim 13, wherein the modem and the one or more antennas are integrated into one of a vehicle, an extra-reality device, or a mobile device.

15. The apparatus of claim 1, further comprising at least one image sensor configured to acquire the frame:

16. A method for performing inpainting of one or more occluded regions in a frame, comprising:
obtaining an occlusion mask corresponding to a first occluded region of one or more occluded regions in the frame, wherein the first occluded region corresponds to a first object;
inputting the frame and the occlusion mask into a first machine learning (ML) model trained to inpaint the frame; and
obtaining as output from the first ML model an inpainted frame that corresponds to the frame with the first object inpainted in the first occluded region.

17. The method of claim 16, wherein obtaining the occlusion mask comprises generating the occlusion mask.

18. The method of claim 17, wherein generating the occlusion mask comprises inputting a sequence of frames comprising the frame into a segmentation model configured to generate the occlusion mask.

19. The method of claim 18, wherein generating the occlusion mask by the segmentation model comprises:
identifying a bounding box associated with the first occluded region;
analyzing pixels within the bounding box to determine a subset of pixels corresponding to the first occluded region; and
creating the occlusion mask based on the subset of pixels.

20. The method of claim 16, wherein the first ML model comprises a diffusion-based inpainting model.
